(19) United States
(12) Patent Application Publication
(10) Pub. No.: US 2007/0156630 A1
(43) Pub. Date: Jul. 5, 2007

(54) System and method for processing a table over a network

(76) Inventors: Carola Steinmaier, Dossenheim (DE); Nikolai Sauerwald, Malsch (DE)

Correspondence Address: KENYON & KENYON LLP, 1500 K STREET N.W., WASHINGTON, DC, 20005, US

(21) Appl. No.: 11/319,424

(22) Filed: Dec. 29, 2005

(51) Int. Cl. G06F 17/30

(52) U.S. Cl. 707/1

(57) ABSTRACT

A system and method for processing a table over a network. According to an embodiment of the invention, a back end application receives one or more requests from a front end application over a network, the one or more requests including an instruction indicating a number of times an action is to be performed on a table, and an identification of one or more table elements associated with the action, and the back end application performs the action on the table for the number of times.

### BACKGROUND OF THE INVENTION

The architecture underlying numerous enterprise software systems entails communication over a network between a front end application and a back end application. It is common for the front end application to interface directly with users (whether human or machine) and forward requests over a network to the back end application, which retrieves requested data or performs a requested service. In regard to the client/server computing model, a front end is generally viewed as the client, and a back end is generally viewed as the server.

Another feature of such enterprise software systems is processing information that is organized into tables. In general, a table is an organized grouping of fields which are most often arranged in rows and columns and stored in a database. In this manner, an enterprise software system may utilize a table to organize data corresponding to particular business inputs.

For example, suppose a company owns 5 different types of vehicles (e.g., 3 nuclear driven ships, 4 oil driven ships, 5 cerosin driven airplanes, 6 gas driven cars and 7 oil driven cars). The company may utilize an enterprise software system that organizes the vehicle information in a table. The rows of the table may represent each of the 25 vehicles, and the columns of the table may represent any particular feature or aspect of those vehicles (e.g., vehicle, engine, length, power, color, etc.).

The system's front end application may expose a user interface so that the company can input instructions corresponding to actions to be performed on the table (e.g., add data to particular fields, add/delete rows, add/delete columns, etc.), and then communicate these instructions over a network to the system's back end application. Upon receiving the instructions, the back end application may then perform the requested actions on the table in the database, which is usually maintained on the back end. When the requested actions have been performed, the back end application may then communicate the updated table information to the front end application for display to the company.

The disadvantage to this architecture is that any time a user wishes to make such a change to the table, the front end application makes a specific communication to the back end application in order to effect the change. For instance, in a situation in which a company may want to add n rows to a table (e.g., to reflect its purchase of n new gas driven cars), the company would have to input a “create new row” instruction n times, which would require n roundtrips between the front end and back end applications over the network. Having the same action performed by the backend n times via n network communications creates a significant performance issue with respect to network traffic, CPU consumption, memory consumption and response time. This significant performance issue is exacerbated even further with respect to stateless applications and communications over a WAN (Wide Area Network).

Accordingly, there is a need in the art for a system and method that reduces current performance issues associated with processing tables over a network.

### BRIEF DESCRIPTION OF THE DRAWINGS

FIG. 1 is a block diagram that depicts a system architecture in accordance with an embodiment of the present invention.

FIG. 2 is a process flow diagram that depicts a table processing process between a front end and back end application in accordance with an embodiment of the present invention.

FIG. 3 is a screenshot that depicts a table as displayed by a front end application in accordance with an embodiment of the present invention.

FIG. 4 is a screenshot that depicts an updated table as displayed by a front end application in accordance with an embodiment of the present invention.

FIG. 5 is a block diagram that depicts a computing device in accordance with an embodiment of the present invention.

### DETAILED DESCRIPTION

The present invention significantly reduces current performance issues associated with processing tables over a network by enabling a front end application to combine into one instruction request what would otherwise be n of the same instruction requests to a back end application.

For example, instead of requiring a user to provide a “create new row” instruction to a front end application n times (which would result in n roundtrip network communications between the front end and back end applications), an embodiment of the present invention would enable a user to provide only one “create new row” instruction along with the number of times that the instruction is to be executed (i.e., n), so that only one roundtrip network communication is needed between the front end and back end applications.

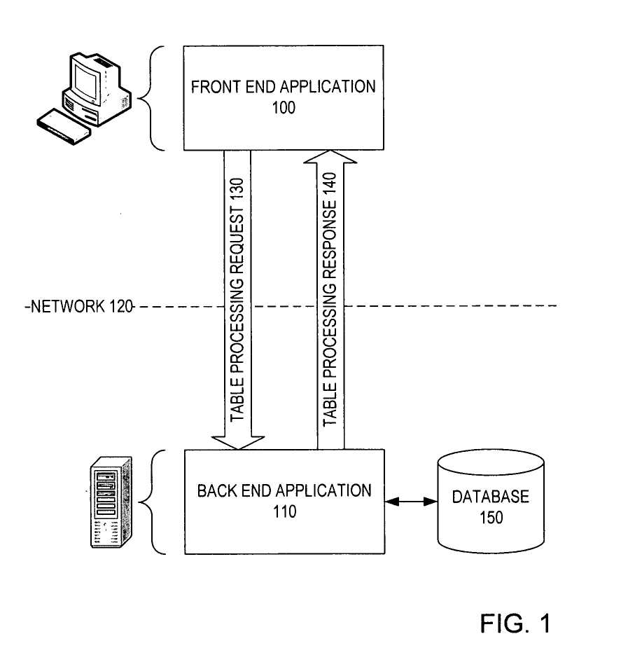

This efficient system architecture is depicted in FIG. 1, which shows an embodiment of the invention in which front end application 100 makes only one table processing request 130 over network 120 to back end application 110. Since the request 130 indicates the number of times an action is to be performed on the table, back end application 110 is able to perform the action on the specified table for the specified number of times, and only respond once to front end application 100 with the updated table information to be displayed to the user. Back end application 110 may retrieve information about the table from database 150, and it may persist updated table information to database 150.

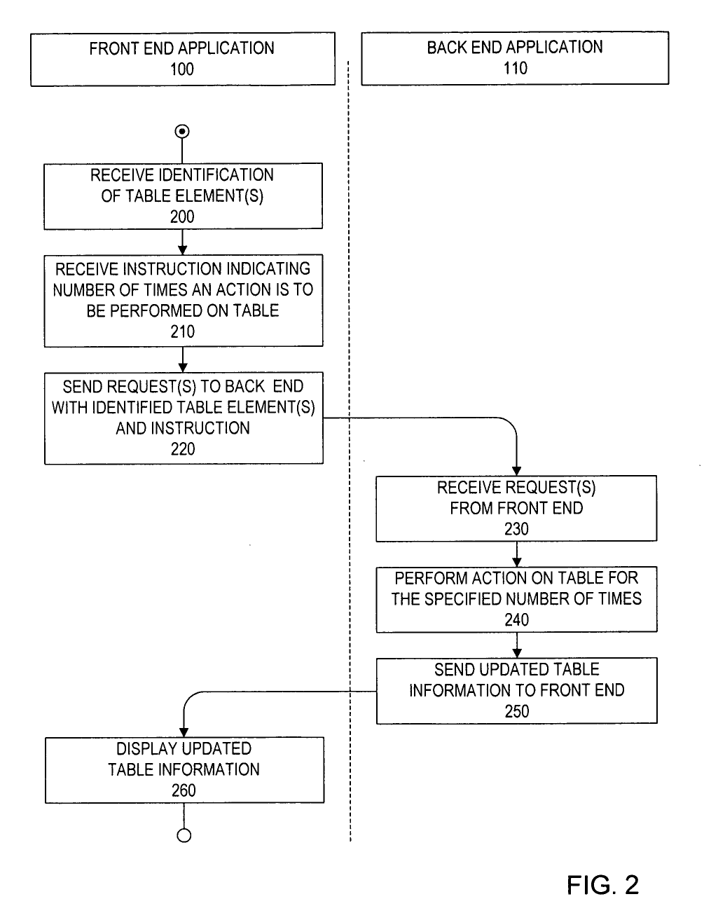

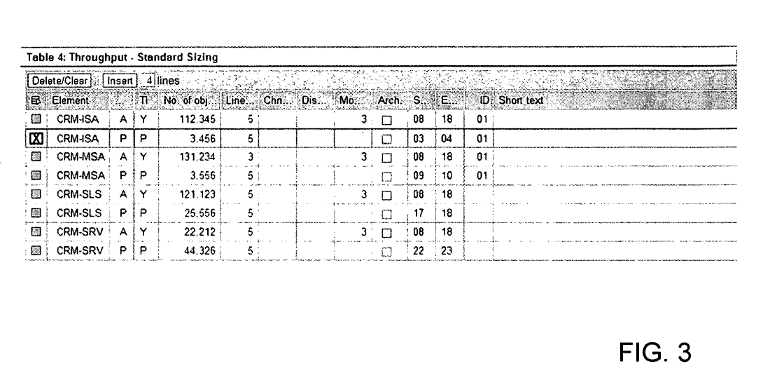

FIG. 2 depicts a corresponding process flow diagram of this interaction in accordance with an embodiment of the invention. In this diagram, front end application 100 receives from a user an identification of table elements (step 200) that are to be associated with an action to be performed on the table. This is illustrated by way of example in FIG. 3, which shows a table in which a user has placed a check box in the left-hand column of the second row of data. This table may include key columns (i.e., columns—such as the “Element” column—whose fields hold key data, which may be used to sort the rows in the table) and regular, non-key columns.

The table of FIG. 3 could represent different types of Customer Relationship Management (“CRM”) orders, for example. Rows with the data value “CRM-ISA” in the “Element” column could represent Internet sales orders, rows with the data value “CRM-MSA” in the “Element” column could represent mobile sales orders, rows with the data value “CRM-SLS” in the “Element” column could represent normal sales orders, and rows with the data value “CRM-SRV” in the “Element” column could represent service orders. The second row of data may represent information for an Internet sales order pertaining to a particular country, and the user may wish to enter information for Internet sales orders pertaining to four additional countries. Thus, the user selects the second row of data because the user desires to insert new rows into the table based on the selected row.

Next, front end application 100 receives from the user an instruction indicating the number of times an action is to be performed on the table (step 210). This is shown in FIG. 3 when a user presses the “Insert” button after entering the number “4” at the top of the table. This informs the front end application that the user wants an insert row action performed on the table four times, and that the inserted rows should be based on the row selected with the check box. In one embodiment, basing the inserted rows on the selected row may signify copying the key data and/or other data of the selected row into the inserted rows.

Upon receiving this information from the user, front end application 100 sends a table processing request 130 to back end application 110 that includes the identified table elements and the instruction (step 220). Upon receiving the request 130 (step 230), back end application 110 performs the requested action on the table for the specified number of times (step 240), and then sends the updated table information to front end application 100 (step 250) so that it may be displayed to the user (step 260).

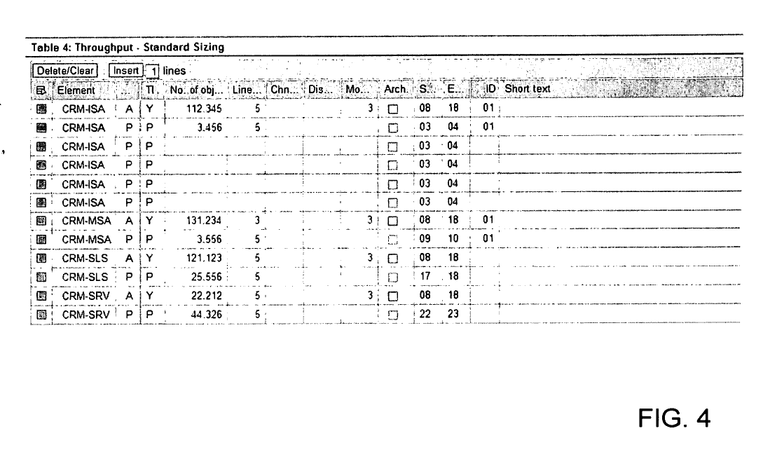

This last step is illustrated in FIG. 4, which shows the table of FIG. 3 updated to include 4 inserted rows based on the row that was selected by the user in the table in FIG. 3 (the second row of data). The 4 inserted rows appear beneath the second row, and certain data from certain fields of the second row have been automatically copied into the corresponding fields of the four new rows, while the remaining fields of the new rows are left blank. In this manner, a user may avoid extra work by only having to fill in the new blank row fields and not having to manually copy over certain data, such as key field or other field data, which is to be the same in the selected row and inserted rows based on the context of the particular field data within the table.

The table may also be structured such that a user may not be allowed to access certain fields, such as copied key fields for example, in an effort to avoid an irregular combination of key values entered by a user. In other embodiments, of course, it may be the case that no key data or other data is copied into the new rows, leaving the task to the user to fill in all new row fields. In some embodiments, certain fields may be intentionally blank and not changeable, and any copied fields based on those fields would retain the same characteristics. Additionally, the placement of the new rows can be in other places besides beneath the selected row, such as at the end or beginning of the table, or above the selected row, for example.

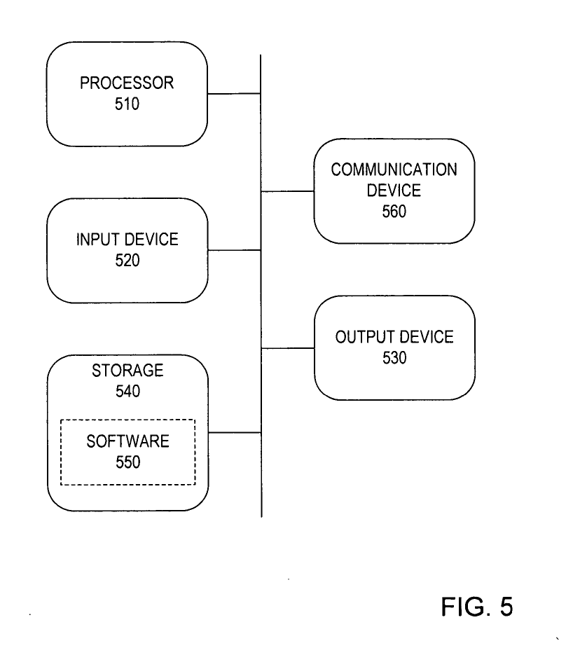

FIG. 5 illustrates the components of a basic computing device in accordance with an embodiment of the present invention, which may include front end application 100 and back end application 110. The computing device may be a personal computer, workstation, handheld personal digital assistant (“PDA”), server, or any other type of microprocessor-based device. The computing device may include one or more of processor 510, input device 520, output device 530, storage 540, and communication device 560.

Input device 520 may include a keyboard, mouse, pen-operated touch screen or monitor, voice-recognition device, or any other device that provides input. Output device 530 may include a monitor, printer, disk drive, speakers, or any other device that provides output.

Storage 540 may include volatile and nonvolatile data storage, including one or more electrical, magnetic or optical memories such as a RAM, cache, hard drive, CD-ROM drive, tape drive or removable storage disk. Communication device 560 may include a modem, network interface card, or any other device capable of transmitting and receiving signals over a network. The components of the computing device may be connected in any manner, such as via electrical bus or wirelessly.

Software 550, which may be stored in storage 540 and executed by processor 510, may include, for example, the application programming that embodies the functionality of the present invention (e.g., as embodied in front end application 100 and back end application 110). Software 550 may include a combination of client applications and enterprise servers such as an application server and a database server.

Network 120 may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software 550 may be written in any programming language, such as ABAP, C, C++, lava or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software modules that implement the present invention such as front end application 100 and back end application 110 may comprise several discrete modules that together still provide the same functionality, data specified in the illustrated table may be spread over several databases and/or systems, and the flow diagram of FIG. 2 may encompass combined steps or several intermediate steps that do not detract from the higher level functionality described therein.

Also, the present invention is not limited to particular actions such as the insert row action described in detail herein. Other embodiments may include actions such as, for example, insert rows based on multiple selected rows, and inserting columns based on one or more selected columns.

What is claimed is:

1. A system for processing a table over a network, comprising:
a front end application module;
a back end application module communicatively linked to the front end application module over a network; and
a database communicatively linked to the back end application module,
wherein the front end application module sends a request to the back end application module over the network, the request including an instruction indicating a number of times an action is to be performed on a table, and an identification of one or more table elements associated with the action, and
wherein the back end application module accesses the database to perform the action on the table for the number of times.

2. The system of claim 1, wherein the back end application module, after performing the action on the table for the number of times, sends to the front end application module updated information corresponding to the table.

3. The system of claim 1, wherein the one or more table elements includes one or more rows of the table selected by a user of the front end application module.

4. The system of claim 3, wherein the action includes inserting into the table one or more new rows based on the one or more selected rows of the table.

5. The system of claim 4, wherein the one or more selected rows of the table include one or more key fields, the key fields holding key data.

6. The system of claim 5, wherein the action further includes copying the key data of the one or more selected rows to the one or more new rows of the table.

7. The system of claim 1, wherein the one or more table elements includes one or more columns of the table selected by a user of the front end application module.

8. The system of claim 7, wherein the action includes inserting into the table one or more new columns based on the one or more selected columns of the table.

9. A method for processing a table over a network, comprising:
receiving by a back end application one or more requests from a front end application over a network, the one or more requests including
an instruction indicating a number of times an action is to be performed on a table, and
an identification of one or more table elements associated with the action; and
performing by the back end application the action on the table for the number of times.

10. The method of claim 9, further comprising:
after performing the action on the table for the number of times, sending to the front end application updated information corresponding to the table.

11. The method of claim 9, wherein the one or more table elements includes one or more rows of the table selected by a user of the front end application.

12. The method of claim 11, wherein the action includes inserting into the table one or more new rows based on the one or more selected rows of the table.

13. The method of claim 12, wherein the one or more selected rows of the table include one or more key fields, the key fields holding key data.

14. The method of claim 13, wherein the action further includes copying the key data of the one or more selected rows to the one or more new rows of the table.

15. The method of claim 9, wherein the one or more table elements includes one or more columns of the table selected by a user of the front end application.

16. The method of claim 15, wherein the action includes inserting into the table one or more new columns based on the one or more selected columns of the table.

17. A system for processing a table over a network, comprising:
means for receiving by a back end application one or more requests from a front end application over a network, the one or more requests including
an instruction indicating a number of times an action is to be performed on a table, and
an identification of one or more table elements associated with the action; and
means for performing by the back end application the action on the table for the number of times.
